(19) United States
(12) Patent Application Publication
(10) Pub. No.: US 2025/0291098 A1
(43) Pub. Date: Sep. 18, 2025

(54) POLARIZATION ELEMENT, METHOD OF MANUFACTURING POLARIZATION ELEMENT, AND OPTICAL APPARATUS

(71) Applicant: Dexerials Corporation, Shimotsuke-shi (JP)

(72) Inventor: Yusuke Matsuno, Shimotsuke-shi (JP)

(73) Assignee: Dexerials Corporation, Shimotsuke-shi (JP)

(21) Appl. No.: 19/077,458

(22) Filed: Mar. 12, 2025

(30) Foreign Application Priority Data
Mar. 14, 2024 (JP) 2024-039789

(51) Int. Cl. G02B 5/30

(52) U.S. Cl. CPC G02B 5/3025

(57) ABSTRACT

Provided is a polarization element including a transparent substrate and lattice-shaped convex portions, the lattice-shaped convex portions being arranged on one surface of the transparent substrate at a pitch shorter than a wavelength of light in a use band and extending in a predetermined direction and having a reflection layer and an absorption layer, in this order from a side of the transparent substrate; a width of the absorption layer being substantially the same as a width of the reflection layer on a side facing the absorption layer; in a cross-sectional view from a direction in which the lattice-shaped convex portions extend, a central plane passing through a center in a width direction of the absorption layer being spaced apart from a central plane passing through a center in a width direction of the reflection layer by a predetermined distance.

This application is based on and claims the benefit of priority from Japanese Patent Application No. 2024-039789, filed on 14 Mar. 2024, the content of which is incorporated herein by reference.

### BACKGROUND OF THE INVENTION

### Field of the Invention

The present invention relates to a polarization element, a method of manufacturing a polarization element, and an optical apparatus.

### Related Art

The polarization element is an optical element that absorbs polarized light in a predetermined direction and transmits polarized light in a direction orthogonal to the polarized light to be absorbed. In principle, the liquid crystal display device requires a polarization element. In particular, a polarization element used in a liquid crystal display device using a light source having a large amount of light such as a liquid crystal projector is required to have heat resistance and to have a size of about several centimeters, a high extinction ratio, and control of reflectance characteristics because the polarization element receives strong radiation. In order to meet these requirements, a wire grid type polarization element has been proposed.

A wire grid type polarization element includes a transparent substrate and lattice-shaped convex portions arranged on one surface of the transparent substrate at a pitch shorter than a wavelength of light in a use band and extending in a predetermined direction (for example, see Patent Document 1). At this time, when light is incident on the polarization element, s-polarized light (TE wave (s wave)) having an electric field component parallel to the extending direction of the lattice-shaped convex portions cannot be transmitted, and p-polarized light (TM wave (p wave)) having an electric field component perpendicular to the extending direction of the lattice-shaped convex portions is transmitted.
Patent Document 1: Japanese Unexamined Patent Application, Publication No. 2020-64326

### SUMMARY OF THE INVENTION

However, in the wire grid type polarization element, when the variation in the incident angles of light is large, transmission axis transmittance may decrease.

An object of the present invention is to provide a polarization element capable of improving the transmission axis transmittance even when the variation in the incident angles of light is large.

A first aspect of the present invention relates to a polarization element including a transparent substrate and lattice-shaped convex portions, the lattice-shaped convex portions being arranged on one surface of the transparent substrate at a pitch shorter than a wavelength of light in a use band and extending in a predetermined direction; the lattice-shaped convex portions having a reflection layer and an absorption layer, in this order from a side of the transparent substrate; a width of the absorption layer being substantially the same as a width of the reflection layer on a side facing the absorption layer; when viewing a cross section in a direction in which the lattice-shaped convex portions extend, a central plane passing through a center in a width direction of the absorption layer being spaced apart from a central plane passing through a center in a width direction of the reflection layer by a predetermined distance.

A second aspect of the present invention relates to the polarization element as described in the first aspect, in which when viewing a cross section in a direction in which the lattice-shaped convex portions extend, in the absorption layer, a ratio of a width of a region existing on one side with respect to the central plane passing through the center in the width direction of the reflection layer to a width of a region existing on the other side with respect to the central plane passing through the center in the width direction of the reflection layer is 0 or more and 45/55 or less.

A third aspect of the present invention relates to the polarization element as described in the second aspect, in which when light in the used band is blue light, a ratio of the widths is 25/75 or more and 40/60 or less, when the light in the used band is green light, the ratio of the widths is 0 or more and 45/55 or less, when the light in the used band is red light, the ratio of the widths is 35/65 or more and 45/55 or less, and when the light in the used band is visible light, the ratio of the widths is 25/75 or more and 45/55 or less.

A fourth aspect of the present invention relates to the polarization element as described in any one of the first to third aspects, in which the transparent substrate includes glass, quartz crystal, quartz, or sapphire.

A fifth aspect of the present invention relates to the polarization element as described in any one of the first to fourth aspects, in which the absorption layer includes a metal material or a semiconductor material.

A sixth aspect of the present invention relates to the polarization element as described in any one of the first to fifth aspects, in which an antireflection layer is provided on the other surface of the transparent substrate.

A seventh aspect of the present invention relates to the polarization element as described in any one of the first to six aspects, in which at least a part of the surface is coated with a protective film, and the protective film includes Si oxide, Ti oxide, Zr oxide, Al oxide, Nb oxide, or Ta oxide.

An eighth aspect of the present invention relates to the polarization element as described in any one of the first to seventh aspects, in which at least a part of the surface is coated with an organic water-repellent film.

A ninth aspect of the present invention relates to a method for manufacturing the polarization element as described in any one of the first to eighth aspects, the method including: forming a reflection layer on one surface of the transparent substrate; selectively etching the reflection layer to form a precursor of the lattice-shaped convex portions; pattern-forming a resist in a region of the one surface of the transparent substrate where the precursor of the lattice-shaped convex portions is not formed; forming an absorption layer on the precursor of the lattice-shaped convex portions and a surface of the resist; and forming the lattice-shaped convex portions by selectively etching the absorption layer.

A tenth aspect of the present invention relates to the method for manufacturing a polarization element as described in the ninth aspect, further including forming an antireflection layer on the other surface of the transparent substrate.

An eleventh aspect of the present invention relates to the method for manufacturing a polarization element as described in the ninth or tenth aspect, further including coating at least a part of the surface with a protective film, in which the protective film includes Si oxide, Ti oxide, Zr oxide, Al oxide, Nb oxide, or Ta oxide.

A twelfth aspect of the present invention relates to the method for manufacturing a polarization element as described in any one of the ninth to eleventh aspects, further including coating at least a part of the surface with an organic water-repellent film.

A thirteenth aspect of the present invention relates to an optical apparatus including the polarization element as described in any one of (1) to (8).

According to the present invention, it is possible to provide a polarization element capable of improving transmission axis transmittance even when variation in the incident angles of light is large.

### BRIEF DESCRIPTION OF THE DRAWINGS

FIG. 1 is a schematic perspective view showing a polarization element according to an embodiment of the present invention;

FIG. 2 is a schematic cross-sectional view showing the polarization element of FIG. 1;

FIGS. 3A, 3B, and 3C are schematic cross-sectional views illustrating modifications of the polarization element of FIG. 1;

FIGS. 4A and 4B are schematic cross-sectional views illustrating modifications of the polarization element of FIG. 1;

FIGS. 5A, 5B, and 5C are schematic cross-sectional views illustrating a method of manufacturing the polarization element of FIG. 1;

FIGS. 6A, 6B, and 6C are schematic cross-sectional views illustrating a method of manufacturing the polarization element of FIG. 1; and

FIGS. 7A, 7B, and 7C are schematic cross-sectional views illustrating a method of manufacturing the polarization element of FIG. 1.

### DETAILED DESCRIPTION OF THE INVENTION

Hereinafter, embodiments of the present invention will be described with reference to the drawings.

### [Polarization Element]

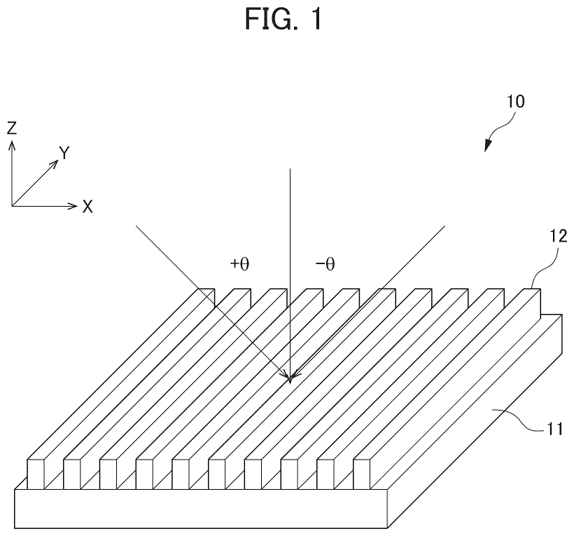

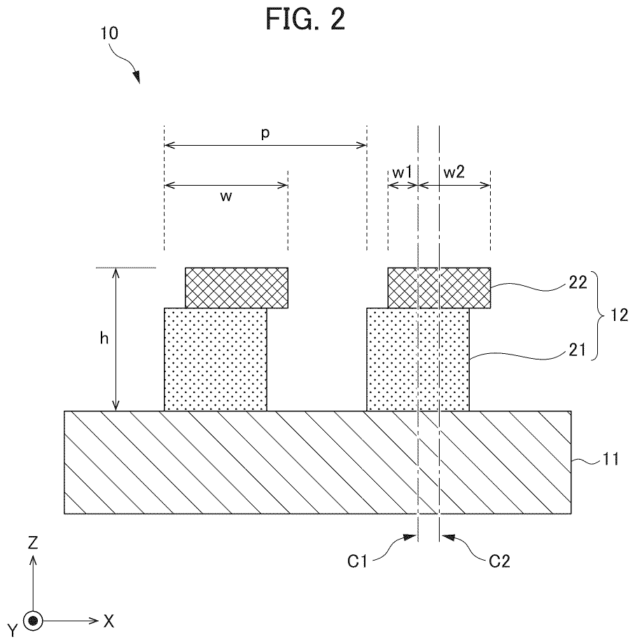

FIGS. 1 and 2 show a polarization element according to an embodiment of the present invention.

A polarization element 10 includes a transparent substrate 11 and lattice-shaped convex portions 12 having a width w and a height h, and the lattice-shaped convex portions are arranged on one surface of the transparent substrate 11 at a pitch p shorter than a wavelength of light in a use band and extend in the Y-axis direction.

Here, as shown in FIGS. 1 and 2, a direction in which the lattice-shaped convex portions 12 extend is referred to as a Y-axis direction. In addition, a direction which is orthogonal to the Y-axis direction and in which the lattice-shaped convex portions 12 are arranged at a pitch p along the main surface of the transparent substrate 11 is referred to as an X-axis direction. Further, a direction orthogonal to the Y-axis direction and the X-axis direction, that is, a direction perpendicular to the main surface of the transparent substrate 11 is referred to as a Z-axis direction. Although the direction in which light is incident on the polarization element 10 is the Z-axis direction, it is preferable that the light is incident on the polarization element 10 from the side where the lattice-shaped convex portions 12 are formed.

The polarization element 10 attenuates s-polarized light (TE wave (s wave)) having an electric field component parallel to the Y-axis direction and transmits p-polarized light (TM wave (p wave)) having an electric field component parallel to the X-axis direction by utilizing four actions: transmission, reflection, interference, and selective light absorption of polarized light by optical anisotropy. Therefore, the Y-axis direction is the direction of the absorption axis of the polarization element 10, and the X-axis direction is the direction of the transmission axis of the polarization element 10.

Here, the height h of a lattice-shaped convex portion 12 means a dimension in the Z-axis direction perpendicular to the main surface of the transparent substrate 11. Further, the width w of the lattice-shaped convex portion 12 means a dimension of the lattice-shaped convex portion 12 in the X-axis direction. Further, the pitch p of the lattice-shaped convex portions 12 means a repeated interval in the X-axis direction of the polarization element 10.

The pitch p of the lattice-shaped convex portions 12 is not particularly limited as long as it is shorter than the wavelength of the light in the use band, but is preferably 100 nm or more and 200 nm or less from the viewpoints of ease of manufacturing and stability of the polarization element 10. The pitch p of the lattice-shaped convex portions 12 can be measured by observation with a scanning electron microscope or a transmission electron microscope. The pitch p of the lattice-shaped convex portions 12 is, for example, an arithmetic average value of measurement values at four randomly selected locations. Hereinafter, such a measurement method is referred to as an electron microscopy method.

As shown in FIG. 2, the lattice-shaped convex portion 12 includes a reflection layer 21 and an absorption layer 22 in this order from the transparent substrate 11 side. Here, the lattice-shaped convex portions 12 have a wire grid structure arranged in a one-dimensional lattice-like shape. The reflection layer 21 and the absorption layer 22 are rectangular in cross section, and the width of the absorption layer 22 is substantially the same as the width of the reflection layer 21 on the side facing the absorption layer 22. Further, when viewed in a cross section from the direction in which the lattice-shaped convex portions 12 extend, a central plane C2 passing through the center in the width direction of the absorption layer 22 is spaced apart from a central plane C1 passing through the center in the width direction of the reflection layer 21 by a predetermined distance. Therefore, even if the variation in the incident angles θ of light is large, the transmission axis transmittance is improved. At this time, it is preferable that a ratio (w1/w2) of a width w1 of a region existing on one side (left side in the drawing) with respect to the central plane C1 passing through the center in the width direction of the reflection layer 21 to a width w2 of a region existing on the other side (right side in the drawing) with respect to the central plane C1 passing through the center in the width direction of the reflection layer 21 of the absorption layer 22 is 0 or more and 45/55 or less. When w1/w2 is 0 or more and 45/55 or less, the transmission axis transmittance is further improved even if the variation in the incident angles θ of light is large.

For example, when the light in the used band is blue light, w1/w2 is preferably 25/75 or more and 40/60 or less, and particularly preferably 25/75. When the light in the used band is green light, w1/w2 is preferably 0 or more and 45/55 or less, and more preferably 25/75. Furthermore, when the light in the used band is red light, w1/w2 is preferably 35/65 or more and 45/55 or less, and particularly preferably 35/65. When the light in the used band is visible light, w1/w2 is preferably 25/75 or more and 45/55 or less, and particularly preferably 25/75.

When the light incident from the side of the transparent substrate 11 on which the lattice-shaped convex portions 12 are formed passes through the absorption layer 22, a part of the light is absorbed and attenuated. Of the light that has passed through the absorption layer 22, p-polarized light (TM wave (p wave)) passes through the reflection layer 21 with high transmittance. On the other hand, of the light that has passed through the absorption layer 22, s-polarized light (TE wave (s wave)) is reflected by the reflection layer 21. The s-polarized light reflected by the reflection layer 21 is partially absorbed when passing through the absorption layer 22, but is partially reflected and returns to the reflection layer 21. The s-polarized light reflected by the reflection layer 21 interferes and attenuates when passing through the absorption layer 22. As described above, the polarization element 10 can obtain desired polarization characteristics by the s-polarized light selectively attenuating.

### (Transparent Substrate)

The material constituting the transparent substrate 11 is not particularly limited as long as it is transparent to light in the use band, and can be appropriately selected according to the purpose. Examples of the light in the use band include visible light having a wavelength of 400 nm or more and 700 nm or less.

“Transparent to light in the use band” means that the material has transmittance of light such that the material is capable of maintaining a function as a polarization element, and does not mean that transmittance of light in the use band is 100%.

The transparent substrate 11 is preferably made of a material having a refractive index of 1.1 or more and 2.2 or less. The material having a refractive index of 1.1 or more and 2.2 or less is not particularly limited, and examples thereof include glass, quartz crystal, quartz and sapphire. Among these, from the viewpoint of cost and light transmittance, quartz and glass are preferable, and quartz having a refractive index of 1.46 and soda-lime glass having a refractive index of 1.51 are particularly preferable. From the viewpoint of thermal conductivity, quartz crystal and sapphire are preferable. Thereby, the heat resistance of the transparent substrate 11 is improved, and can be used in a liquid crystal projector.

When an optically active crystalline substance such as quartz crystal or sapphire is used as the material constituting the transparent substrate 11, it is preferable to dispose the lattice-shaped convex portions 12 in a direction parallel to or perpendicular to the optic axis of the crystalline substance. Thereby, excellent optical characteristics can be obtained. Here, the optic axis is a direction axis along which a difference in refractive index between 0 (ordinary ray) and E (abnormal ray) of light traveling in the direction is minimized.

The average thickness of the transparent substrate 11 is not particularly limited, but is, for example, 0.3 mm or more and 1 mm or less. The shape of the main surface of the transparent substrate 11 is not particularly limited, and may be, for example, a rectangular shape.

### (Reflection Layer)

The reflection layer 21 is formed on one surface of the transparent substrate 11, and constitutes lattice-shaped convex portions 12 extending in the Y-axis direction. The reflection layer 21 attenuates s-polarized light (TE wave (s wave)) having an electric field component in the Y-axis direction and transmits p-polarized light (TM wave (p wave)) having an electric field component in the X-axis direction.

The thickness of the reflection layer 21 is not particularly limited, but is, for example, 100 nm or more and 300 nm or less. The thickness of the reflection layer 21 is measured, for example, by the electron microscopy method.

The material constituting the reflection layer 21 is not particularly limited as long as it is capable of reflecting light in the use band, and examples thereof include a simple substance of an element such as Al, Ag, Cu, Mo, Cr, Ti, Nd, Ni, W, Fe, Si, Ge, Te or the like, and an alloy containing one or more of these elements. Among these, aluminum or an aluminum alloy is preferable. The reflection layer 21 may be, for example, a resin film or an inorganic film other than a metal whose surface reflectance is increased by coloring.

The method of forming the reflection layer 21 is not particularly limited, and examples thereof include a vapor deposition method and a sputtering method.

The reflection layer 21 may be a laminate in which layers made of different constituent materials are laminated.

### (Absorption Layer)

The absorption layer 22 is formed on the surface of the reflection layer 21, and constitutes the lattice-shaped convex portions 12 extending in the Y-axis direction.

The thickness of the absorption layer 22 is not particularly limited, but is, for example, 5 nm or more and 50 nm or less. The thickness of the absorption layer 22 is measured by, for example, the electron microscopy method.

The material constituting the absorption layer 22 is not particularly limited as long as it can absorb light in the use band, and examples thereof include metal materials and semiconductor materials. Examples of the metal materials include a simple substance of an element such as Ta, Al, Ag, Cu, Au, Mo, Cr, Ti, W, Ni, Fe, Sn, or the like and an alloy containing one or more of these elements. Examples of the semiconductor materials include Si, Ge, Te, ZnO, and a silicide material (β-FeSi₂, MgSi₂, NiSi₂, BaSi₂, CrSi₂, CoSi₂, TaSi, etc.). Among them, a material containing Fe or Ta and Si is preferable.

When a semiconductor material is used as the material constituting the absorption layer 22, it is necessary to use a semiconductor material having bandgap energy equal to or less than the energy of light in the use band. For example, in a case where light in a use band is visible light, it is necessary to use a semiconductor material having a band gap energy equal to or less than energy of light having a wavelength of 400 nm, that is, 3.1 eV or less.

A method of forming the absorption layer 22 is not particularly limited, and examples thereof include a vapor deposition method and a sputtering method.

The absorption layer 22 may be a laminate in which layers made of different materials are laminated.

### (Antireflection Layer)

The polarization element 10 may include an antireflection layer on the other surface of the transparent substrate 11. The antireflection layer is, for example, a laminate in which low refractive index layers and high refractive index layers having different refractive indexes are alternately laminated.

The material constituting the antireflection layer is not particularly limited, and examples thereof include Si oxide, Ti oxide, Zr oxide, Al oxide, Nb oxide, and Ta oxide.

The thickness of the antireflection layer is not particularly limited, but is, for example, 1 nm or more and 500 nm or less. The thickness of the antireflection layer is measured, for example, by the electron microscopy method.

The method of forming the antireflection layer is not particularly limited, and examples thereof include a vapor deposition method, a sputtering method, a CVD (Chemical Vapor Deposition) method, and an ALD (Atomic Layer Deposition) method. Among them, an ion beam assisted deposition (IAD) method and an ion beam sputtering (IBS) method are preferable.

### (Protective Film)

At least a part of the surface of the polarization element 10 may be coated with a protective film. This improves the durability of the polarization element 10.

The material constituting the protective film is the same as the material constituting the antireflection layer.

The method of forming the protective film is not particularly limited, and examples thereof include a CVD method and an ALD method.

Note that the protective film may be a laminate in which layers made of different materials are laminated.

### (Organic Water-Repellent Film)

At least a part of the surface of the polarization element 10 may be coated with an organic water-repellent film. This improves the moisture resistance of the polarization element 10.

The material constituting the organic water-repellent film is not particularly limited, and examples thereof include a fluorine-based silane coupling agent such as tridecafluorooctyltrichlorosilane (FOTS).

The method of forming the organic water-repellent film is not particularly limited, and examples thereof include a CVD method, an ALD method, and a coating method.

### (Simulation)

It was verified by simulation that the transmission axis transmittance of the polarization element 10 was improved even when the variation in the incident angles θ of light was large. Specifically, the simulation was performed using Gsolver (manufactured by Grating Solver Development) under the following conditions. Next, the average value of the transmission axis transmittance when the incident angle of light was −45°, −30°, −15°, 0°, 15°, 30°, and 45° was obtained.
Refractive index of transparent substrate 11: 1.5
Widths of the reflection layer 21 and the absorption layer 22: 28 nm
Height of the reflection layer 21: 250 nm
The material constituting the reflection layer 21: Al
Height of the absorption layer 22: 35 nm
Material constituting the absorption layer 22: FeSi
w1/w2: 50/50, 45/55, 40/60, 35/65, 25/75 and 0
Wavelength range of blue light: 430 to 510 nm
Wavelength range of green light: 520 to 590 nm
Wavelength range of red light: 600 to 680 nm
Wavelength region of visible light: 400 to 700 nm
Incident angle of light: −45°, −30°, −15°, 0°, 15°, 30°, 45°

Table 1 shows the evaluation results of the average value of the transmission axis transmittance.

TABLE 1

| | w1/w2 | | | | | |
|---|---|---|---|---|---|---|
| | 50/50 | 45/55 | 40/60 | 35/65 | 25/75 | 0 |
| Blue light | 85.105 | 85.092 | 85.144 | 85.193 | 85.218 | 84.973 |
| Green light | 87.414 | 87.454 | 87.533 | 87.605 | 87.731 | 87.638 |
| Red light | 88.748 | 88.768 | 88.778 | 88.769 | 88.742 | 88.248 |
| Visible light | 86.645 | 86.653 | 86.689 | 86.714 | 86.721 | 86.333 |

From Table 1, it can be seen that when the incident angle of visible light was 0°±45°, the transmission axis transmittance was improved in the case where w1/w2 was 25/75 or more and 45/55 or less as compared with the case where w1/w2 was 50/50. When the incident angle of blue light was 0°±45°, the transmission axis transmittance was improved in the case where w1/w2 was 25/75 or more and 40/60 or less as compared with the case where w1/w2 was 50/50. Further, when the incident angle of green light was 0°±45°, the transmission axis transmittance was improved in the case where w1/w2 was 0 or more and 45/55 or less as compared with the case where w1/w2 was 50/50. Further, when the incident angle of red light was 0°±45°, the transmission axis transmittance was improved in the case where w1/w2 was 35/65 or more and 45/55 or less as compared with the case where w1/w2 was 50/50.

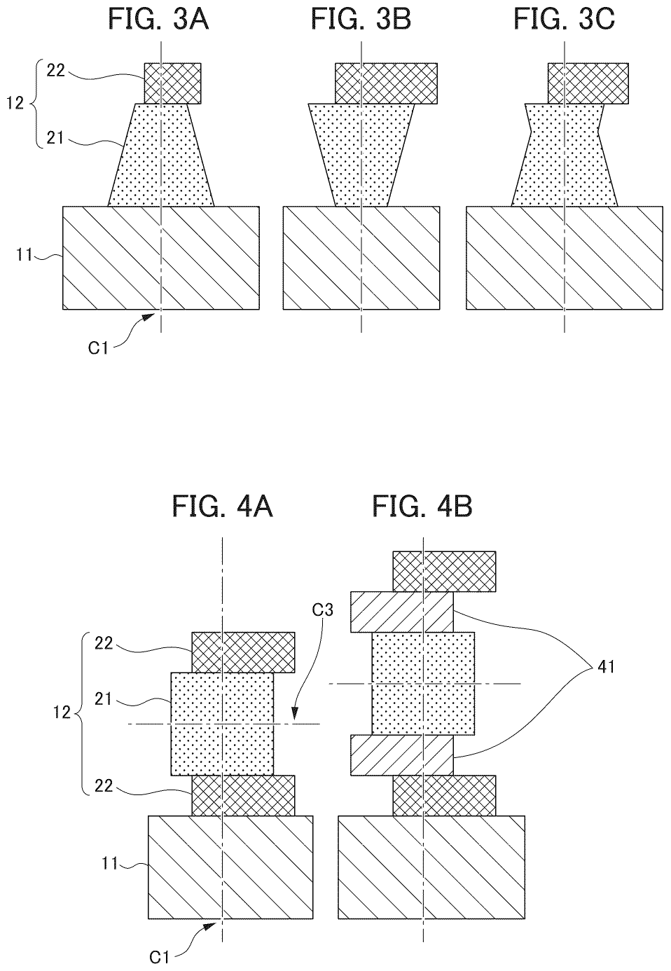

The cross-sectional shape of the reflection layer 21 is not particularly limited as long as the width of the reflection layer 21 on the side facing the absorption layer 22 is substantially the same as the width of the absorption layer 22. The cross-sectional shape of the reflection layer 21 may be, for example, a trapezoidal shape in which the width continuously increases or decreases (see FIGS. 3A and 3B), or a hexagonal shape in which the width continuously decreases and then increases (see FIG. 3C).

In addition, the lattice-shaped convex portion 12 is not particularly limited as long as it includes the reflection layer 21 and the absorption layer 22 in this order from the transparent substrate 11 side. The lattice-shaped convex portion 12 may further include, for example, the absorption layer 22 between the transparent substrate 11 and the reflection layer 21 (see FIG. 4A). In this case, the absorption layers 22 disposed on both sides of the reflection layer 21 are disposed in line symmetry with respect to a central plane C3 passing through the center of the reflection layer 21 in the height direction. At this time, the lattice-shaped convex portion 12 may further include an intermediate layer 41 between the reflection layer 21 and the absorption layer 22 (see FIG. 4B). In this case, the intermediate layers 41 disposed on both sides of the reflection layer 21 are disposed in line symmetry with respect to the central plane C3 passing through the center of the reflection layer 21 in the height direction. An interval between the central plane passing through the center in the width direction of the intermediate layer 41 and the central plane passing through the center in the width direction of the reflection layer 21 is substantially the same as the interval between the central plane passing through the center in the width direction of the absorption layer 22 and the central plane passing through the center in the width direction of the reflection layer 21, but the absorption layer 22 and the intermediate layer 41 are disposed on the opposite side in the width direction with respect to the central plane C1 passing through the center in the width direction of the reflection layer 21. The intermediate layer 41 is not particularly limited, and examples thereof include the absorption layer, the reflection layer, and the antireflection layer.

### [Method for Manufacturing Polarization Element]

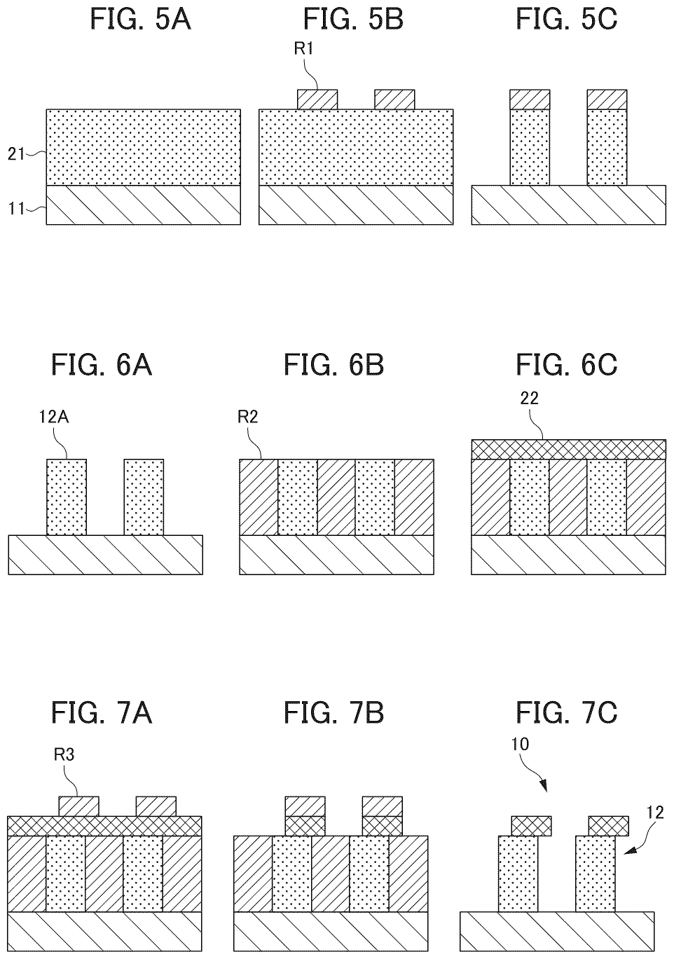

A method of manufacturing the polarization element 10 will be described with reference to FIGS. 5A, 5B, 5C, 6A, 6B, 6C, 7A, 7B, and 7C.

First, the reflection layer 21 is formed on one surface of the transparent substrate 11 (see FIG. 5A), and a resist R1 is pattern formed on the surface of the reflection layer 21 (see FIG. 5B). Next, after the reflection layer 21 is selectively etched (see FIG. 5C), the resist R1 is removed to form a precursor 12A of the lattice-shaped convex portion (see FIG. 6A). Next, after a resist R2 is pattern formed in a region of one surface of the transparent substrate 11 where the precursor 12A of the lattice-shaped convex portion is not formed (see FIG. 6B), the absorption layer 22 is formed on the surfaces of the precursor 12A of the lattice-shaped convex portion and the resist R2 (see FIG. 6C). Next, after a resist R3 is pattern formed on the surface of the absorption layer 22 (see FIG. 7A), the absorption layer 22 is selectively etched (see FIG. 7B). Finally, the resists R2 and R3 are removed to form the lattice-shaped convex portions 12, thereby obtaining the polarization element 10 (see FIG. 7C).

The resist pattern formation method is not particularly limited, and examples thereof include a photolithography method and a nanoimprint method. The etching method is not particularly limited, and examples thereof include a dry etching method using an etching gas corresponding to an etching target.

An antireflection layer may be formed on the other surface of the transparent substrate 11. At least a part of the surface may be coated with a protective film, or at least a part of the surface may be coated with an organic water-repellent film.

### [Optical Apparatuses]

The polarization element 10 can be applied to, for example, optical apparatuses such as a liquid crystal display, a liquid crystal projector, a head-up display, and a headlight of a vehicle. Among these, a liquid crystal projector is preferable in consideration of heat resistance of the polarization element 10.

When an optical apparatus includes a plurality of polarization elements, it is sufficient if at least one of the plurality of polarization elements is the polarization element 10. For example, in the liquid crystal projector, it is sufficient if at least one of the polarization elements disposed on the incident side and the emission side of the liquid crystal panel is the polarization element 10.

Although the embodiments of the present invention have been described above, the present invention is not limited to the above-described embodiments, and the above-described embodiments may be appropriately modified within the scope of the gist of the present invention.

### EXPLANATION OF REFERENCE NUMERALS

10: Polarization element
11: Transparent substrate
12: Lattice-shaped convex portion
12A: Precursor of lattice-shaped convex portion
21: Reflection layer
22: Absorption layer
41: Intermediate layer
C1, C2, and C3: Central planes
R1, R2, and R3: Resists

What is claimed is:

1. A polarization element comprising a transparent substrate and lattice-shaped convex portions,
the lattice-shaped convex portions being arranged on one surface of the transparent substrate at a pitch shorter than a wavelength of light in a use band and extending in a predetermined direction,
the lattice-shaped convex portions having a reflection layer and an absorption layer, in this order from a side of the transparent substrate,
a width of the absorption layer being substantially the same as a width of the reflection layer on a side facing the absorption layer,
when viewing a cross section in a direction in which the lattice-shaped convex portions extend, a central plane passing through a center in a width direction of the absorption layer being spaced apart from a central plane passing through a center in a width direction of the reflection layer by a predetermined distance.

2. The polarization element according to claim 1,
wherein when viewing a cross section in a direction in which the lattice-shaped convex portions extend, in the absorption layer, a ratio of a width of a region existing on one side with respect to the central plane passing through the center in the width direction of the reflection layer to a width of a region existing on the other side with respect to the central plane passing through the center in the width direction of the reflection layer is 0 or more and 45/55 or less.

3. The polarization element according to claim 2,
wherein when light in the used band is blue light, a ratio of the widths is 25/75 or more and 40/60 or less,
when the light in the used band is green light, the ratio of the widths is 0 or more and 45/55 or less,
when the light in the used band is red light, the ratio of the widths is 35/65 or more and 45/55 or less, and
when the light in the used band is visible light, the ratio of the widths is 25/75 or more and 45/55 or less.

4. The polarization element according to claim 1,
wherein the transparent substrate comprises glass, quartz crystal, quartz, or sapphire.

5. The polarization element according to claim 1,
wherein the absorption layer comprises a metal material or a semiconductor material.

6. The polarization element according to claim 1,
wherein an antireflection layer is provided on the other surface of the transparent substrate.

7. The polarization element according to claim 1,
wherein at least a part of the surface is coated with a protective film, and
the protective film comprises Si oxide, Ti oxide, Zr oxide, Al oxide, Nb oxide, or Ta oxide.

8. The polarization element according to claim 1,
wherein at least a part of the surface is coated with an organic water-repellent film.

9. A method for manufacturing the polarization element according to claim 1, the method comprising:
forming a reflection layer on one surface of the transparent substrate;
selectively etching the reflection layer to form a precursor of the lattice-shaped convex portions;
pattern-forming a resist in a region of the one surface of the transparent substrate where the precursor of the lattice-shaped convex portions is not formed;
forming an absorption layer on the precursor of the lattice-shaped convex portions and a surface of the resist; and
forming the lattice-shaped convex portions by selectively etching the absorption layer.

10. The method for manufacturing a polarization element according to claim 9,
further comprising forming an antireflection layer on the other surface of the transparent substrate.

11. The method for manufacturing a polarization element according to claim 9,
further comprising coating at least a part of the surface with a protective film,
wherein the protective film comprises Si oxide, Ti oxide, Zr oxide, Al oxide, Nb oxide, or Ta oxide.

12. The method for manufacturing a polarization element according to claim 9,
further comprising coating at least a part of the surface with an organic water-repellent film.

13. An optical apparatus comprising the polarization element according to claim 1.
